(19) United States
(12) Patent Application Publication
(10) Pub. No.: US 2014/0142900 A1
(43) Pub. Date: May 22, 2014

(54) INFORMATION PROCESSING APPARATUS, INFORMATION PROCESSING METHOD, AND PROGRAM

(71) Applicant: SONY CORPORATION, Tokyo (JP)

(72) Inventor: Alexis Andre, Tokyo (JP)

(73) Assignee: SONY CORPORATION, TOKYO (JP)

(21) Appl. No.: 14/057,471

(22) Filed: Oct. 18, 2013

(30) Foreign Application Priority Data
Nov. 20, 2012 (JP) 2012-254166

(51) Int. Cl. G06F 17/50

(52) U.S. Cl. CPC G06F 17/50
USPC 703/1

(57) ABSTRACT

There is provided an information processing apparatus including an image acquisition section which acquires a series of input images projecting processes in which individual elements are removed from a real model constructed from a plurality of elements, a recognition section which recognizes an element configuration of the real model by using the input images acquired by the image acquisition section, and a determination section which determines a construction procedure for constructing the real model based on the element configuration recognized by the recognition section.

### CROSS REFERENCE TO RELATED APPLICATIONS

This application claims the benefit of Japanese Priority Patent Application JP 2012-254166 filed Nov. 20, 2012, the entire contents of which are incorporated herein by reference.

### BACKGROUND

The present disclosure relates to an information processing apparatus, an information processing method, and a program.

In the conditions for the assembly of a toy, furniture or electrical appliance, for example, work is performed which constructs one real model from a plurality of elements (parts) in accordance with instructions. In particular, in the case where an end user undertakes the construction work, it is important that accurate and easy to understand instructions are provided. Usually, instructions are created by a specialist using a tool such as CAD (Computer Aided Design), based on the design of a model. If the creation of these instructions can be automatically performed, it will be beneficial from the viewpoint of productivity of the product in accordance with the instructions.

However, automatically deriving a construction procedure of this model from a given model will not necessarily be easy. Accordingly, U.S. Pat. No. 7,979,251 has proposed a semi-automatic solution in accordance with interactions with a user. In the technology proposed by U.S. Pat. No. 7,979,251, first the completed form of a model is displayed on the screen of a computer. Then, the elements to be removed from the model are sequentially selected by a user, and the sequence of removal steps is stored by the computer. A sequence of construction steps for the instructions is guided by reversing the sequence of the stored removal steps.

### SUMMARY

The technology proposed by U.S. Pat. No. 7,979,251 assumes that a complete digital representation of the model is prepared in advance, and that the user handles the model on a computer. However, the user himself or herself handling the model on a computer can become a burden for a user who is not a specialist, in terms of both skill and economy Further, since a digital representation of a model does not usually exist, for a real model originally constructed by an end user, instructions are not able to be created for this real model by using the technology presented in U.S. Pat. No. 7,979,251. Nowadays, when an information exchange between users is activated in accordance with advancements of the communication environment, the need to share a user's original model with other users is increasing. Existing technology does not sufficiently satisfy this need.

Therefore, it is desirable to provide an improved mechanism, in which a user is capable of easily creating instructions for constructing a real model, as a target for various models.

According to an embodiment of the present disclosure, there is provided an information processing apparatus including an image acquisition section which acquires a series of input images projecting processes in which individual elements are removed from a real model constructed from a plurality of elements, a recognition section which recognizes an element configuration of the real model by using the input images acquired by the image acquisition section, and a determination section which determines a construction procedure for constructing the real model based on the element configuration recognized by the recognition section.

Further, according to an embodiment of the present disclosure, there is provided an information processing method executed by an information processing apparatus, the method including acquiring a series of input images projecting processes in which individual elements are removed from a real model constructed from a plurality of elements, recognizing an element configuration of the real model by using the acquired input images, and determining a construction procedure for constructing the real model based on the recognized element configuration.

Further, according to an embodiment of the present disclosure, there is provided a program for causing a computer which controls an information processing apparatus to function as an image acquisition section which acquires a series of input images projecting processes in which individual elements are removed from a real model constructed from a plurality of elements, a recognition section which recognizes an element configuration of the real model by using the input images acquired by the image acquisition section, and a determination section which determines a construction procedure for constructing the real model based on the element configuration recognized by the recognition section.

According to the technology according to the embodiments of the present disclosure, it becomes possible for a user to easily create instructions for constructing a real model, as a target for various models.

### BRIEF DESCRIPTION OF THE DRAWINGS

FIG. 1 is an explanatory diagram for describing an outline of an information processing apparatus according to an embodiment of the present disclosure;

FIG. 2A is a first explanatory diagram for describing an example of elements constituting a model;

FIG. 2B is a second explanatory diagram for describing an example of elements constituting a model;

FIG. 3 is a block diagram which shows an example of a hardware configuration of the information processing apparatus according to an embodiment of the present disclosure;

FIG. 4 is a block diagram which shows an example of a functional configuration of the information processing apparatus according to an embodiment of the present disclosure;

FIG. 5 is an explanatory diagram for describing an example of a configuration of feature data;

FIG. 6 is an explanatory diagram for describing an example of an element configuration;

FIG. 7 is an explanatory diagram for describing a model corresponding to the element configuration shown in FIG. 6;

FIG. 8 is an explanatory diagram which shows a state in which an element is removed from a real model;

FIG. 9 is an explanatory diagram for describing a first technique for identifying elements;

FIG. 10 is an explanatory diagram for describing a second technique for identifying elements;

FIG. 11 is an explanatory diagram for describing a third technique for identifying elements;

FIG. 12 is an explanatory diagram for describing an example of a technique for recognizing an arrangement of elements;

FIG. 13 is a first explanatory diagram for describing an example of an element configuration of a real model described in the order of removed elements;

FIG. 14 is a second explanatory diagram for describing an example of an element configuration of a real model described in the order of removed elements;

FIG. 15 is an explanatory diagram for describing an example of a technique for determining a construction procedure of a real model;

FIG. 16 is a flow chart which shows an example of the flow of processes executed by the information processing apparatus according to an embodiment of the present disclosure;

FIG. 17 is an explanatory diagram which shows a first example of instructions which can be created in accordance with the technology according to the present disclosure;

FIG. 18 is an explanatory diagram which shows a second example of instructions which can be created in accordance with the technology according to the present disclosure;

FIG. 19 is a block diagram which shows an example of a functional configuration of the information processing apparatus according to a modified example of the present disclosure; and

FIG. 20 is an explanatory diagram which shows an example of instructions which can be created in a modified example of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Outline of the embodiments

2. Configuration of the information processing apparatus

2-1. Hardware configuration example

2-2. Functional configuration example

2-3. Example of the flow of processes

2-4. Example of instructions

3. Modified example

4. Conclusion

### 1. Outline of the Embodiments

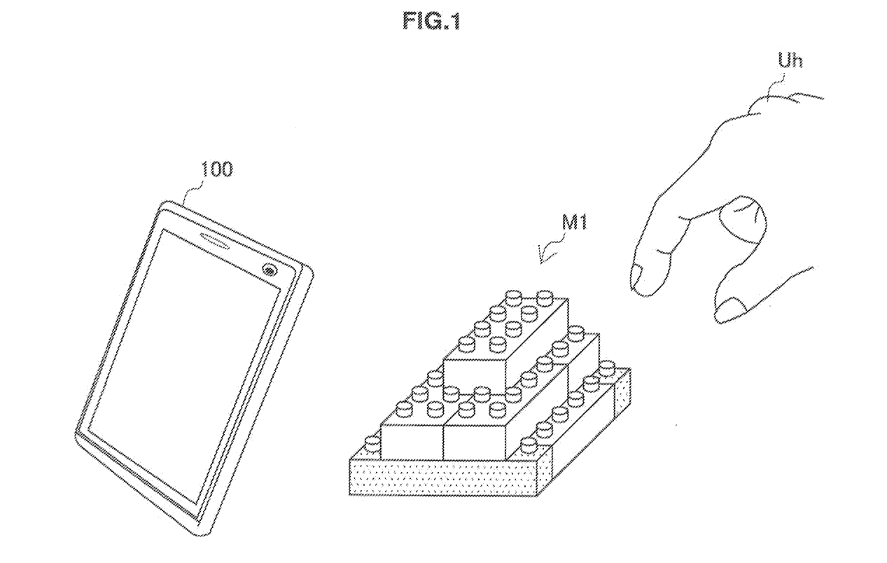

FIG. 1 is an explanatory diagram for describing an outline of an information processing apparatus according to an embodiment of the present disclosure. With reference to FIG. 1, an information processing apparatus 100, a real model M1, and the hand of a user Uh are shown. In the present disclosure, a model is said to be an object constructed by assembling a plurality of elements. The elements are the parts constituting the model. A model physically constructed in a real space is said to be a real model. On the other hand, a model conceptually designed (not in accordance with a physical entity) is said to be a conceptual model.

In the technology proposed by U.S. Pat. No. 7,979,251, an image of a completed conceptual model is displayed on the screen of a computer, and a user sequentially selects the elements to be removed from the conceptual model via a user interface. On the other hand, in the technology according to the present disclosure, the information processing apparatus 100 images the processes in which a user sequentially removes the actual elements from the real model. Then, the information processing apparatus 100 recognizes an element configuration of the real model, based on a series of imaged images. As can be understood from the example of FIG. 1, there is the possibility that elements exist which are not able to be viewed from the outside, at a stage prior to when the elements are removed. Accordingly, a complete element configuration of the model can be recognized after the removal of elements has been completed by the user, without being provided from the beginning.

In the present embodiment, the visual features (for example, one or more from among the color, shape and size) of the elements constituting the model are standardized in advance. Also, the elements are classified into a finite number of types depending on these visual features.

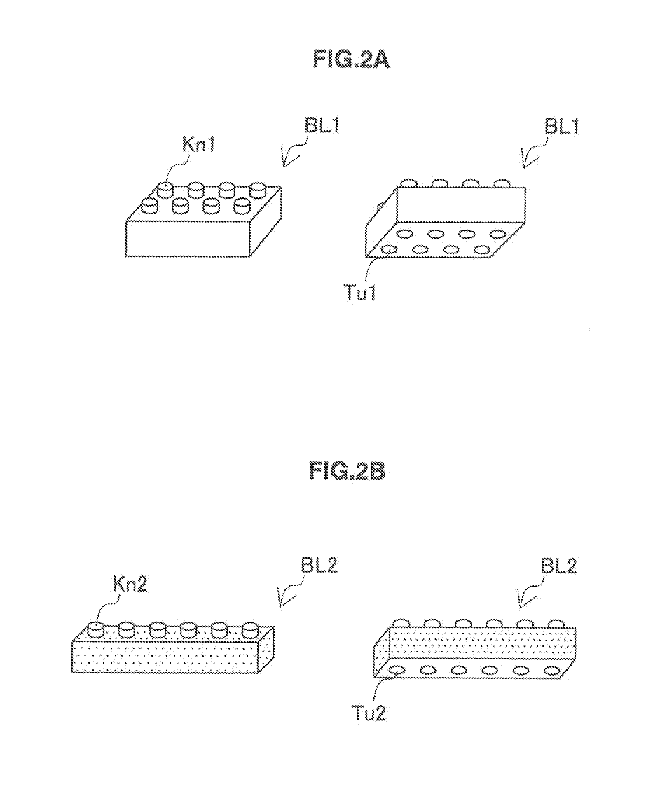

In the example of FIG. 1, the elements constituting the real model M1 are blocks for a toy. A first type of block BL1 is shown in FIG. 2A. The block BL1 has 8 knobs Kn1 arranged in a 4×2 matrix shape on this upper surface. Further, the block BL1 has 8 recesses Tu1 arranged in a 4×2 matrix shape on this lower surface. For example, the user can mutually interlock two of the blocks BL1, by inlaying the knobs Kn1 of the lower block into the recesses TU1 of the upper block BL1 by superimposing the two blocks BL1 up and down. A second type of block BL2 is shown in FIG. 2B. The block BL2 has 6 knobs Kn2 arranged in a 6×1 matrix shape on this upper surface. Further, the block BL2 has 6 recesses TU2 arranged in a 6×1 matrix on this lower surface. The shape of the knobs Kn2 of the block BL2 may be the same as the shape of the knobs Kn1 of the block BL1, and the shape of the recesses Tu2 of the block BL2 may be the same as the shape of the recesses Tu1 of the block BL1. The pitch between adjacent knobs and the gap between adjacent recesses may be the same. In this way, the user can freely interlock the block BL1 and the block BL2. Note that the blocks shown here are merely one example. That is, blocks which have another size or another shape may be used as elements for constituting the real model.

In the following description, an example will be mainly described in which the technology according to the present disclosure is applied to a model constructed from blocks for a toy. However, the use of the technology according to the present disclosure is not limited to such an example. For example, it is possible to apply the technology according to the present disclosure to furniture constructed from elements such as planks, square timber, bolts and nuts, or to electrical appliances constructed from elements such as housings, substrates and cables.

### 2. Configuration of the Information Processing Apparatus

The information processing apparatus 100 may be a generic apparatus such as a PC (Personal Computer), a smartphone, a PDA (Personal Digital Assistant) or a game terminal, or may be a specialist apparatus implemented in order to create instructions. In the present section, a detailed configuration of the information processing apparatus 100 will be described.

### [2-1. Hardware Configuration Example]

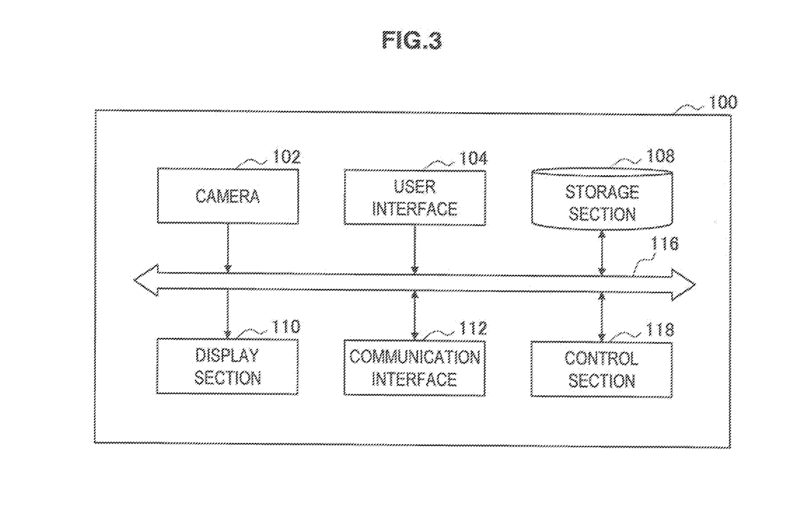

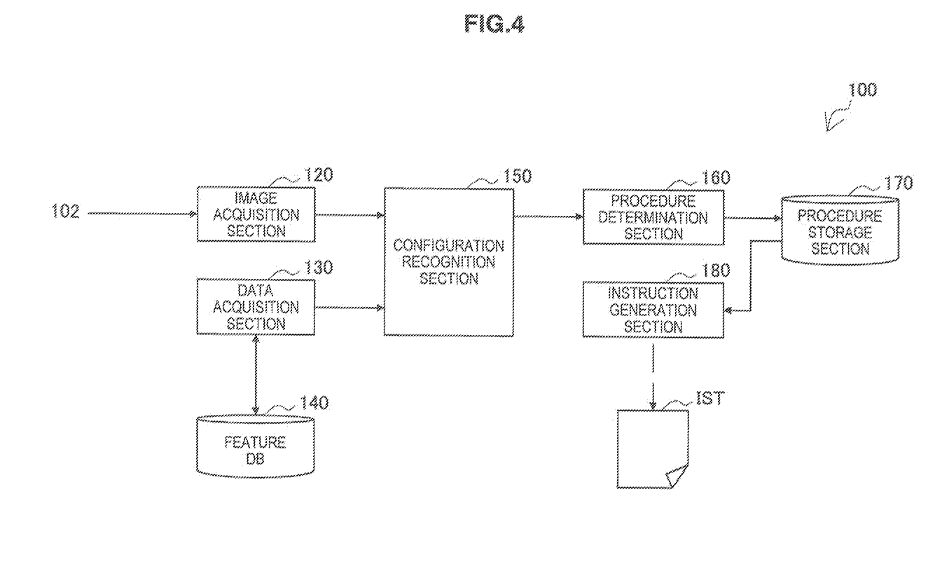

FIG. 3 is an explanatory diagram for describing an example of a hardware configuration of the information processing apparatus 100. With reference to FIG 3, the information processing apparatus 100 includes a camera 102, a user interface 104, a storage section 108, a display section 110, a communication interface 112, a bus 116, and a control section 118.

The camera 102 has, for example, imaging sensors such as a CCD (Charge Coupled Device) or a CMOS (Complementary Metal Oxide Semiconductor), and performs imaging of images.

The user interface 104 includes, for example, an input device such as a touch sensor, a pointing device, a keyboard, buttons or switches. Further, the user interface 104 may include a voice recognition module which recognizes voice commands originating from the user. The user interface 104 provides a user interface for the user to operate the information processing apparatus 100, and detects a user input.

The storage section 108 has a storage medium such as a semiconductor memory or a hard disk, and stores data and programs used by the control section 118. Note that a part of the data and programs described in the present disclosure may not be stored by the storage section 108, and may instead be acquired from an external data source (for example, a data server, a network storage, an external memory or the like).

The display section 110 is constituted of an LCD (Liquid Crystal Display), an OLED (Organic Light-Emitting Diode), a CRT (Cathode Ray Tube) or the like, and displays output images generated by the information processing apparatus 100.

The communication interface 112 establishes a communication connection between the information processing apparatus 100 and another apparatus, in accordance with an arbitrary wireless communication protocol or wired communication protocol.

The bus 116 mutually connects the camera 102, the user interface 104, the storage section 108, the display section 110, the communication interface 112, and the control section 118.

The control section 118 corresponds to a processor such as a CPU (Central Processing Unit) or a DSP (Digital Signal Processor). The control section 118 operates various functions of the information processing apparatus 100, by executing the programs stored in the storage section 108 or another storage medium.

### [2-2. Functional Configuration Example]

FIG. 4 is a block diagram which shows an example of a configuration for the logical functions implemented by the storage section 108 and the control section 118 of the information processing apparatus 100 shown in FIG. 3. With reference to FIG. 4, the information processing apparatus 100 includes an image acquisition section 120, a data acquisition section 130, a feature database (DB) 140, a configuration recognition section 150, a procedure determination section 160, a procedure storage section 170, and an instruction generation section 180.

### (1) The Image Acquisition Section

The image acquisition section 120 acquires, from the camera 102, a series of input images (that is, an input video) projecting the processes in which the individual elements are removed from the real model. Also, the image acquisition section 120 outputs the acquired input images to the configuration recognition section 150.

### (2) The Data Acquisition Section

The data acquisition section 130 acquires feature data which shows the existing visual features of each of the elements constituting the real model. In the present embodiment, the feature data is stored by the feature DB 140 in advance. As another embodiment, for example, the data acquisition section 130 may transmit a request to an external data server (for example, a server of an enterprise or the like which manufactures or sells sets of elements) via the communication interface 112, or may acquire the feature data received from this data server. Also, the data acquisition section 130 outputs the acquired feature data to the configuration recognition section 150.

### (3) The Feature DB

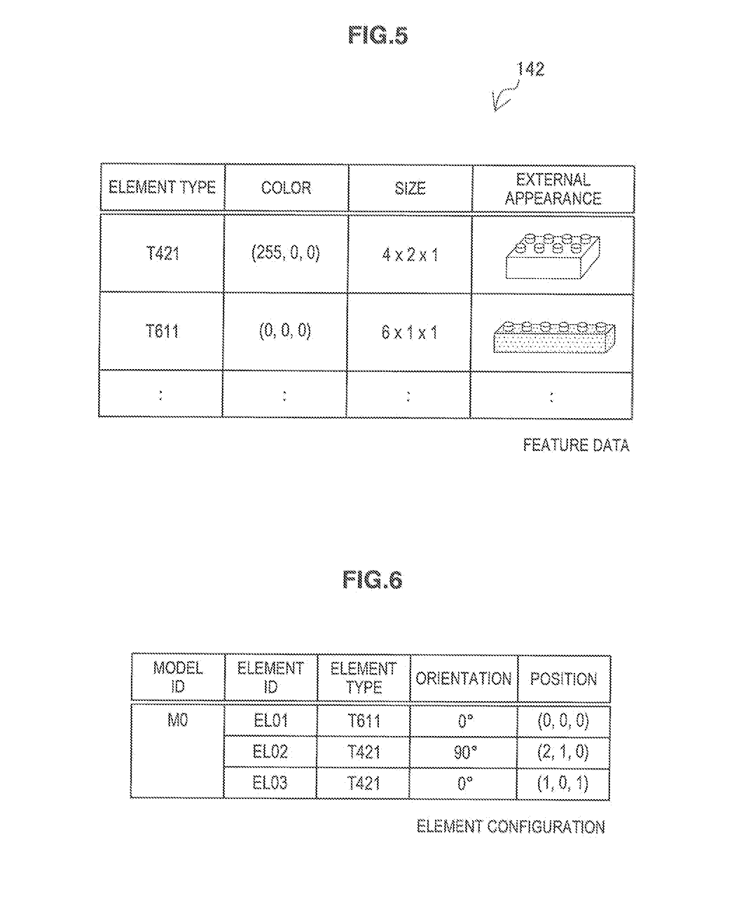

The feature DB 140 is a database which stores feature data. FIG. 5 shows a configuration of feature data 142 as an example. With reference to FIG. 5, the feature data 112 has the four data items of “element type”, “color”, “size”, and “external appearance”.

The “element type” is a character string which identities the type of each element. Different types are provided for elements having different visual features. In the example of FIG. 5, two kinds of element types “T421 ” and “T611” are defined.

The “color” represents the color for each element type. In the example of FIG. 5, the color of the element type T421 is red (RGB=[225, 0, 0]), and the color of the element type T611 is black (RGB=[0, 0, 0]).

The “size” represents the size for each element type. In the example of FIG. 5, the size of the element type T421 is 4×2×1, and the size of the element type T611 is 6×1×1.

The “external appearance” can include a sample image, or a set of feature quantities extracted from a sample image, for each element type. The extraction of the image feature quantities from a sample image may be performed, for example, in accordance with an arbitrary well-known technique such as a Random Ferns method or a SURF method.

### (4) The Configuration Recognition Section

The configuration recognition section 150 recognizes the element configuration of the real model. In the present embodiment, the element configuration includes element identification information and arrangement information for each of the plurality of elements constituting the real model.

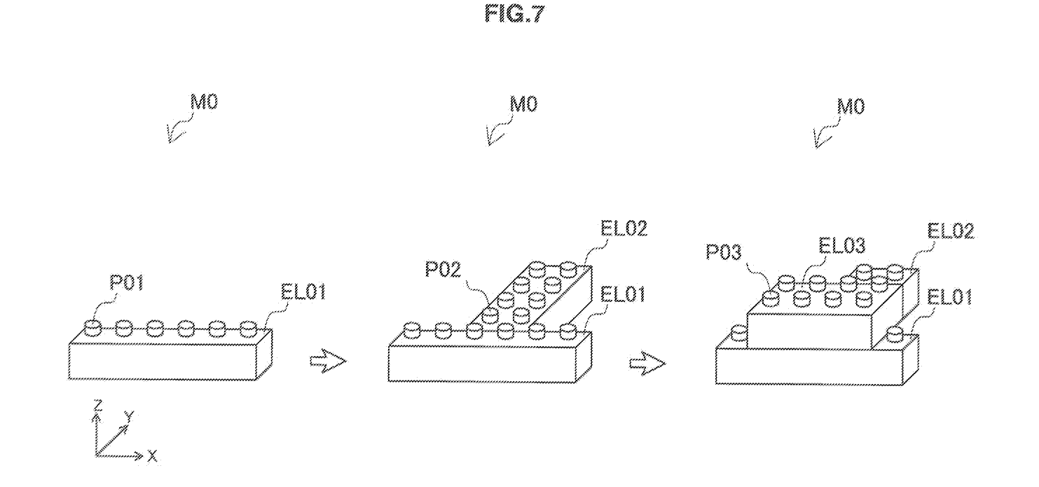

FIG. 6 is an explanatory diagram for describing an example of an element configuration. FIG. 7 is an explanatory diagram for describing a model corresponding to the element configuration shown in FIG. 6.

With reference to FIG. 6, an element configuration of a model MO is shown as an example. In addition to a “model ID” which identifies the model, the element configuration is also defined by the four data items of “element ID”, “element type”, “orientation”, and “position”. The “element ID” and the “element type” correspond to the element identification information. The “element ID” is an identifier for uniquely identifying individual elements within the model. The “element type” represents the type of each element. The “orientation” and “position” correspond to the arrangement information. The “orientation” represents the orientation of each element on the basis of the coordinate system of this model. The “position” represents the position of each element on the basis of the coordinate system of this model.

In the example of FIG. 6, the model M0 is constituted of the three elements EL01, EL02, and EL03. The element EL01 belongs to the element type T611, and is arranged in an orientation 0° and at a position (0, 0, 0). The element EL02 belongs to the element type T421, and is arranged in an orientation 90° and at a position (2, 1, 0). The element EL03 belongs to the element type T421, and is arranged in an orientation 0° and at a position (1, 0, 1).

The coordinate system of the model sets a point on any one of the elements in the model (typically, the element initially appearing in the construction procedure) as an origin, and is set so as to be suitable for the characteristics of the elements. The entry of the element EL01 of FIG. 6 shows that the origin of the coordinate system of the model M0 exists on the element EL01. With reference to FIG. 7, a configuration of the model M0 is shown in accordance with this construction procedure. Only the element EL01 is shown in the left part of FIG. 7, and the origin of the X-Y-Z coordinate system is set to a position P01 of the knob of one end of the element EL01 (the left end within the figure). For example, the X-Y plane is a horizontal plane, and the X-axis, the Y-axis, and the Z-axis can each correspond to a long direction of the upper surface or lower surface of the element EL01, a short direction of the upper surface or lower surface of the element EL01, and a height direction, respectively. The coordinate values of the X-axis and the Y-axis can be scaled by setting the pitch of the knobs and recesses as units. The coordinate values of the Z-axis can be scaled by setting the height of the thinnest element as a unit. Note that, while not limited to such an example, the unit for each coordinate value may be scaled in an absolute length such as millimeters or centimeters. Further, in order for simplicity of the description here, an example will be shown in which the orientation of each element changes only in the horizontal plane. However, while not being limited to such an example, the orientation of each element may change three-dimensionally. For example, in the case where elements are adopted in which the knobs are arranged on a surface with an angle that is not zero with respect to the horizontal plane, the orientation of the elements can rotate apart from the horizontal plane. Further, elements may be adopted which have a universal joint mechanism capable of freely rotating the orientation. In this case, the orientation of each element may be expressed by Eulerian angles or a quaterion.

In addition to the element EL01, an element EL02 is also shown in the center part of FIG. 7. The orientation of the element EL02 is rotated 90° on the X-Y plane, from the orientation defined in the feature data 142. The position P02 of the left front knob of the element EL02 has the coordinates (2, 1, 0) which are only moved “2” in the X direction, “1” in the Y direction, and “0” in the Z direction from the origin P01.

In addition to the elements EL01 and EL02, an element EL03 is also shown in the right part of FIG. 7. The orientation of the element EL03 is not rotated from the orientation defined in the feature data 142. The position P03 of the left from knob of the element EL03 has the coordinates (1, 0, 1) which are only moved “1” in the X direction, “0” in the Y direction, and “1” in the Z direction from the origin P01.

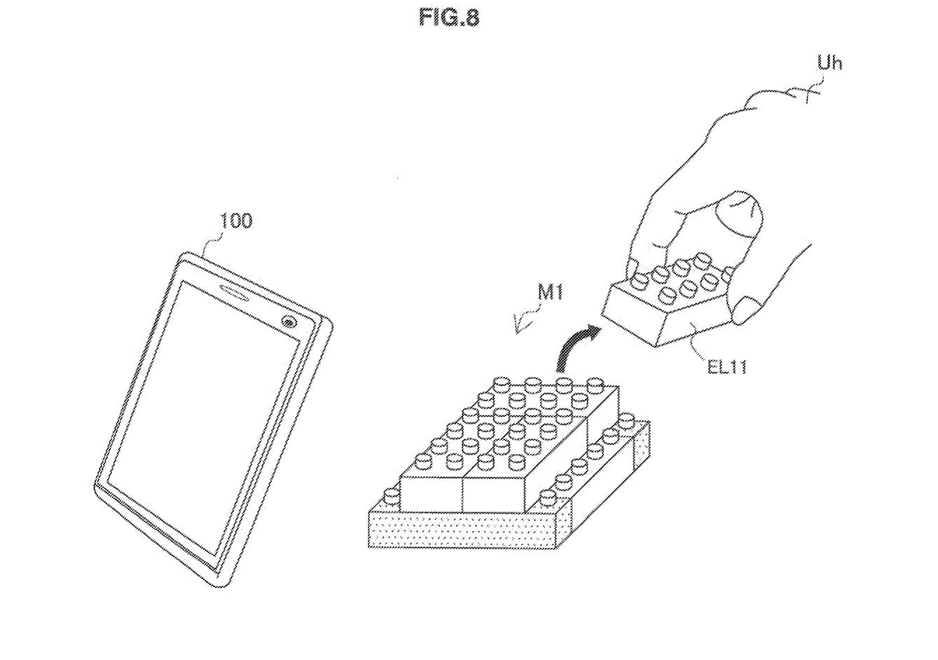

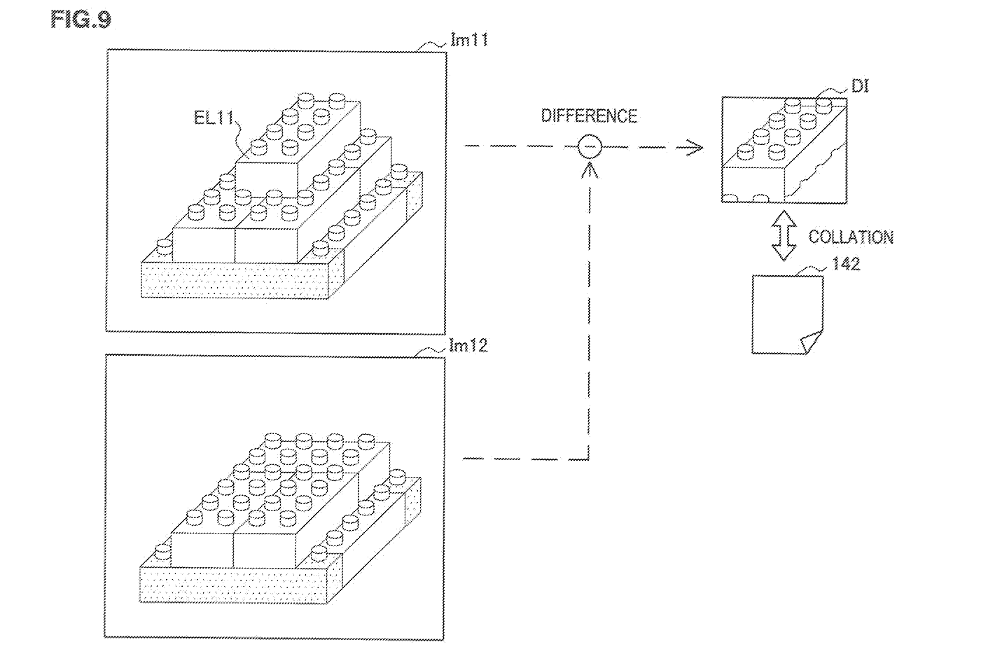

In the case where a user does not construct a real model while referring to a conceptual model prepared in advance, a complete element configuration such as that described in FIGS. 6 and 7 will not be able to be provided for the constructed real model. Accordingly, the configuration recognition section 150 recognizes after the fact the element configuration of the real model, by using a series of input images projecting the processes in which the individual elements are removed from the real model, which are obtained by the image acquisition section 120. A state in which the element EL11 is removed by the user from the real model M1 is shown in FIG. 8.

Hereinafter, three examples of techniques for identifying the elements removed from the real model by the configuration recognition section 150 will be described by using FIGS. 9 to 11.

In the first technique, the configuration recognition section 150 recognizes the element configuration of the real model, by collating the features of the elements projected in the input images with the feature data acquired by the data acquisition section 130. More specifically, each time an element is removed from the real model, the configuration recognition section 150 calculates a difference between a first model image prior to the removal of the element and a second model image after the removal. Then, the configuration recognition section 150 identifies the removed element, by collating the visual features appearing in the calculated difference with the feature data. In the example of FIG. 9, a difference is calculated between a model image Im11 prior to when the element EL11 is removed from the real model M1, and a model image Im12 after the element EL11 is removed from the real model M1, and a partial image D1 of the difference region is generated. Then, the partial image D1 is collated with the feature data 142.

For example, in the case where all the element types are capable of being uniquely identified by only a color, the configuration recognition section 150 may collate the features of the colors of the partial image D1 with a color for each element type shown by the feature data 142. Further, for example, the configuration recognition section 150 may recognize the shape of the elements projected in the partial image D1, by using a well-known shape recognition algorithm such as an SFS (Shape from Shading) method or an SFM (Structure from Motion) method, and may collate the recognized shape with a shape for each element type shown by the feature data 142. Further, the configuration recognition section 150 may collate a feature quantity set extracted from the partial image D1 with an existing feature quantity set for each element type included in the feature data 142. In the example of FIG. 9, by using one or more of these methods, it can be identified that the element EL11 removed from the real model M1 is an element that belongs to the element type T421.

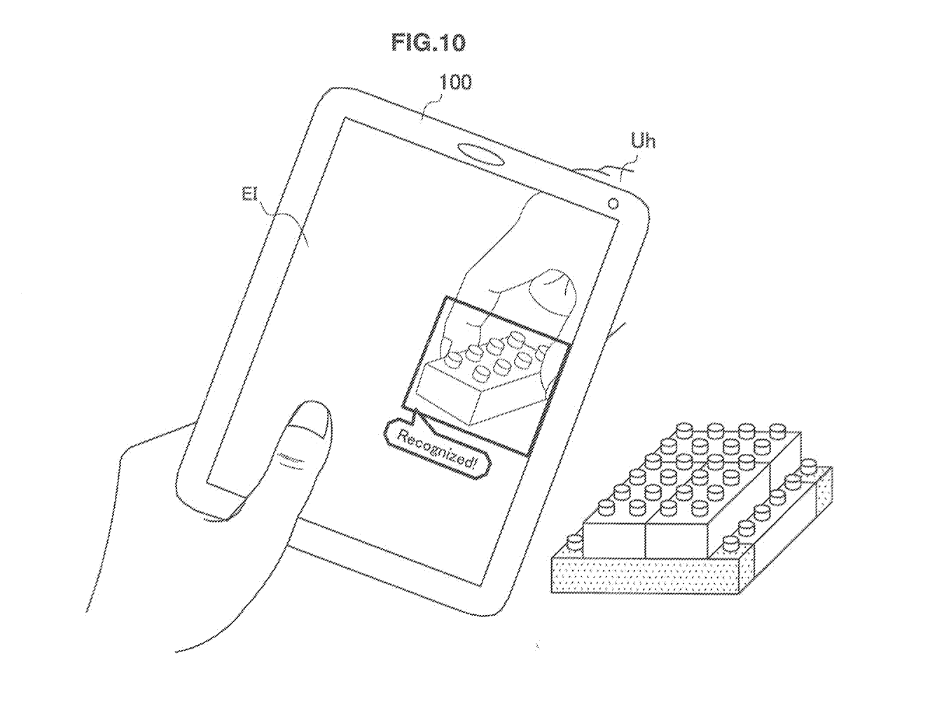

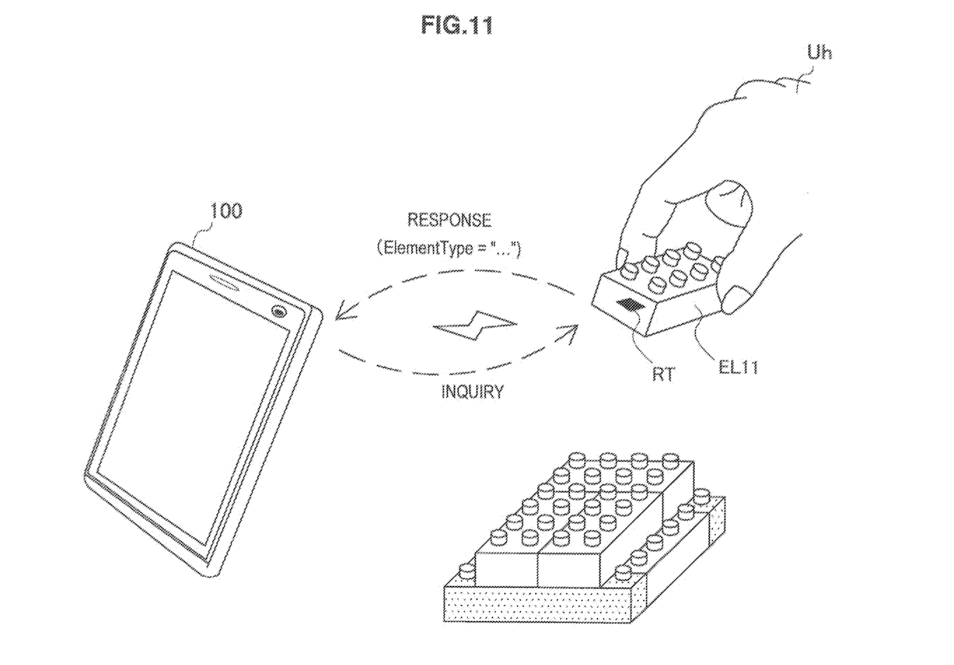

Also in the second technique, the configuration recognition section 150 recognizes the element configuration of the real model, by collating the features of the elements projected in the input images with the feature data acquired by the data acquisition section 130. However, in the second technique, each time an element is removed from the real model, the user presents the removed element to the camera of the information processing apparatus 100. The configuration recognition section 150 identifies each element, by collating the visual features appearing in the element images of the presented elements with the feature data input from the data acquisition section 130. In the example of FIG. 10, the element removed by the user from the real model M1 is projected in an element image E1, and the element is recognized within the element image E1, For example, the configuration recognition section 150 can collate one or more from among a color, a shape and a feature quantity set of the recognized element with existing information shown by the feature data 142. In this way, the configuration recognition section 150 can identify the element type of the elements removed from the real model M1.

In the third technique, the configuration recognition section 150 does not use the feature data acquired by the data acquisition section 130. Alternatively, each element has identification information, which identifies this element, within the element or on an element surface. For example, the identification information here may be information stored by an RF (Radio Frequency) tag built into the element, or information shown by a one-dimensional or two-dimensional bar code attached to the element surface. The configuration recognition section 150 identifies each element, by reading such identification information from each removed element. In the example of FIG. 11, the element EL11 has an RF tag RT built into the element, and when the information processing apparatus 100 transmits an inquiry signal, a response signal including the identification information of the element EL11 is returned from the RF tag RT. The configuration recognition section 150 can identify the element type of the element EL11, by using such read identification information.

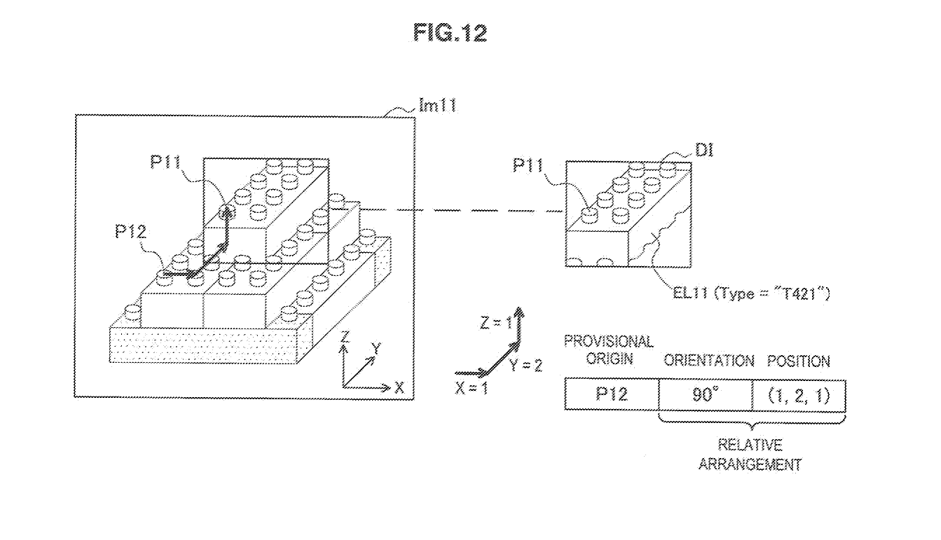

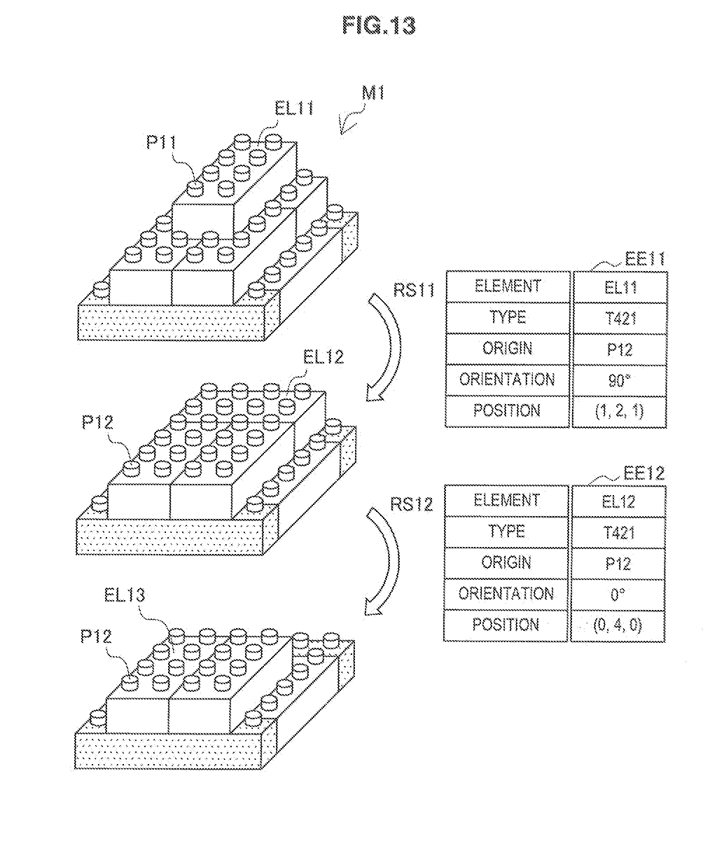

The configuration recognition section 150 can recognize, for example, the arrangement in the real model of each element removed from the real model, based on a difference between the above described first model image and the above described second model image. FIG. 12 is an explanatory diagram for describing an example of a technique for recognizing an arrangement of the elements. With reference to FIG. 12, the first model image Im11 and the partial image D1 of the difference region shown in the example of FIG. 9 are again shown. The element EL11 is projected in the partial image D1, and the element EL11 belongs to the element type T421. The plurality of elements remaining in the model M1 is projected in the first model image Im11. For example, the configuration recognition section 150 sets a position P12 of the upper left front knob of the model M1 to an origin of a provisional coordinate system, and on the basis of the position P12, the coordinates of a position P11 of the left front knob of the element EL11 are judged. In the example of FIG. 12, the position P11 has the coordinates (1, 2, 1). The element EL11 is rotated 90° in the X-Y plane. Each time an element is removed from the real model, the configuration recognition section 150 judges in this way the relative arrangement of the removed elements, and element identification information and arrangement information are output to the procedure determination section 160.

### (5) The Procedure Determination Section

The procedure determination section 160 determines the construction procedure for constructing the real model, based on the element configuration recognized by the configuration recognition section 150. More specifically, the procedure determination section 160 describes, within the element configuration data, the element identification information and arrangement information output from the configuration recognition section 150 in the order of the removed elements. Then, when the removal of elements by the user is completed, the procedure determination section 160 determines the construction procedure, by reversing the order of the element identification information and arrangement information within the element configuration data.

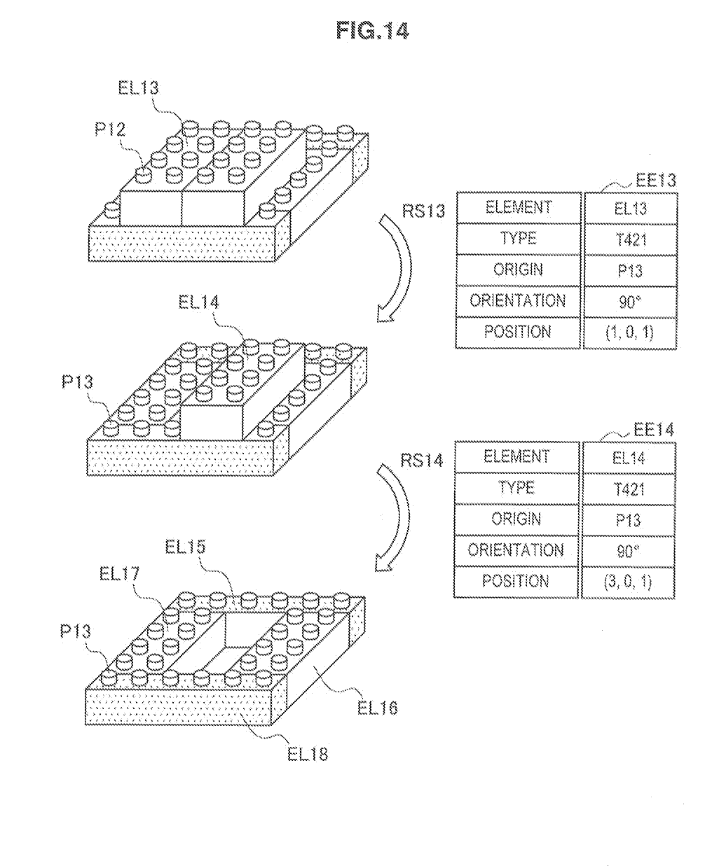

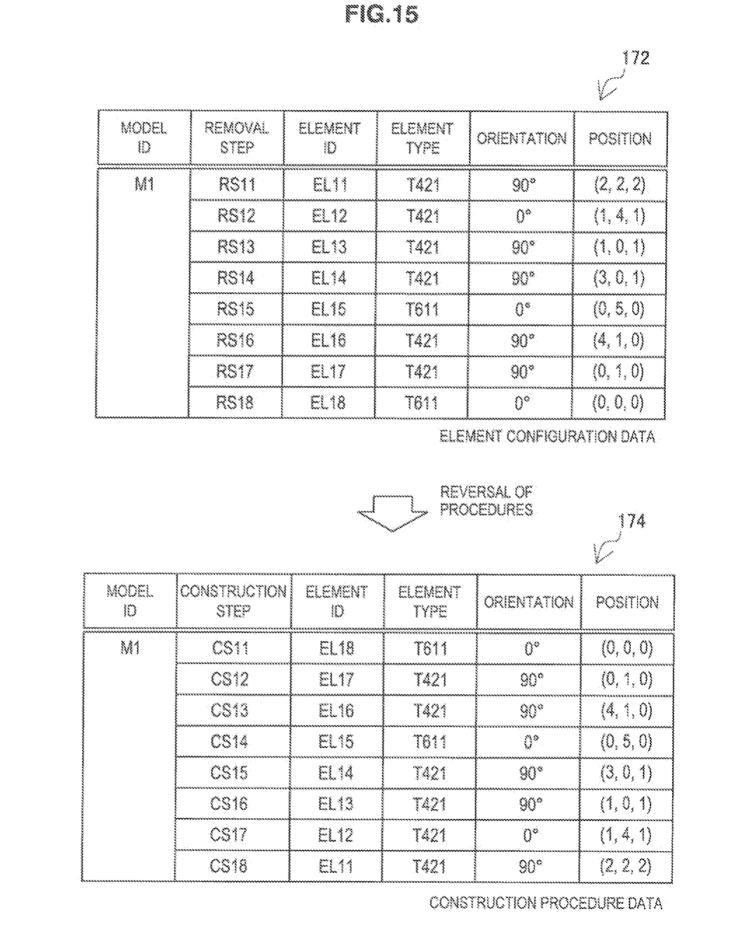

FIGS. 13 and 14 are explanatory diagrams for describing an example of the element configuration of the real model disclosed in the order of the removed elements.

A completed real model M1 is shown in the upper part of FIG. 13. In a first removal step RS11, a user removes the element EL11 which is positioned on the uppermost part of the real model M1. As a result of this, an element configuration entry EE11 is generated for the removed element EL11. The element configuration entry EE11 shows that the entry EL11 belongs to the element type T421, and has an orientation of 90° and coordinates (1, 2, 1) on the basis of a provisional origin P12.

In a second removal step RS12, the user removes the element EL12 which is positioned on the upper back of the real model M1. As a result of this, an element configuration entry EE12 is generated for the removed element EL12. The element configuration entry EE12 shows that the entry EL12 belongs to the element type T421, and has an orientation of 0° and coordinates (0, 4, 0) on the basis of the provisional origin P12.

With reference to FIG. 14, in a third removal step RS13, the user removes the element EL13 which is positioned on the upper left front of the real model M1. As a result of this, an element configuration entry EE13 is generated for the removed element EL13. The element configuration entry EE13 shows that the entry EL13 belongs to the element type T421, and has an orientation of 90° and coordinates (1, 0, 1) on the basis of a provisional origin P13.

In a fourth removal step RS14, the user removes the element EL14 which is positioned in the upper right front of the real model M1. As a result of this, an element configuration entry EE14 is generated for the removed element EL14. The element configuration entry EE14 shows that the entry EL14 belongs to the element type T421, and has an orientation of 90° and coordinates (3, 0, 1) on the basis of the provisional origin P13.

After the fourth removal step RS14, the four elements EL15, EL16, EL17, and EL18 remain in the real model M1. While the removal of the elements can be continued from this point onwards, in order to avoid a redundant description, this will be omitted from this description.

FIG. 15 is an explanatory diagram for describing an example of a technique for determining the construction procedure of the real model. Element configuration data 172 is shown, in the upper part of FIG. 15, for the model M1 as an example, which include the element configuration entries EE11 to EE14 described by using FIGS. 13 and 14. Within the element configuration data 172, the element configuration entries are described in the order in which the elements are removed. The procedure determination section 160 provides data items (removal steps) which show the removal step number for each element configuration entry in the example of FIG. 15, removal step numbers “RS11” to “RS18” are provided for the 8 element configuration entries. Further, the procedure determination section 160 corrects the position coordinates of each element configuration entry to coordinates on the basis of one common origin from coordinates on the basis of a provisional origin. In the example of FIG. 15, the position P13 is selected as a common origin (refer to FIG. 14). Then, for example, the position coordinates (1, 2, 1) of the element EL11, which were determined on the basis of the origin P12 in the removal step RS11 of FIG. 13, are corrected to the position coordinates (2, 2, 2) on the basis of the origin P13. Similarly, the position coordinates (0, 4, 0) of the element EL12, which were determined on the basis of the origin P12 in the removal step RS12, are corrected to the position coordinates (1, 4, 1) on the basis of the origin P13.

The procedure determination section 160 generates construction procedure data 174 such as that shown in the lower part of FIG. 15, by reversing the order of the element identification information (for example, the element ID and the element type) and the arrangement information (for example, the orientation and the position) within the element configuration data 172. The construction procedure data 174 has the six data items of “model ID”, “construction step”, “element ID”, “element type”, “orientation”, and “position”. The five data items other than the “construction step” are the same as those of the element configuration data 172. The “construction step” is a number which shows the order in which each element is to be assembled in the construction procedure. A first construction step CS11 corresponds to the eighth (final) removal step RS18 in the element configuration data 172. A second construction step CS12 corresponds to the seventh removal step RS17 in the element configuration data 172. A third construction step CS13 corresponds to the sixth removal step RS16 in the element configuration data 172. A fourth construction step CS14 corresponds to the fifth removal step RS15 in the element configuration data 172. A fifth construction step CS15 corresponds to the fourth removal step RS14 in the element configuration data 172. A sixth construction step CS16 corresponds to the third removal step RS13 in the element configuration data 172. A seventh construction step CS17 corresponds to the second removal step RS12 in the element configuration data 172. An eighth construction step CS18 corresponds to the first (initial) removal step RS11 in the element configuration data 172.

The procedure determination section 160 stores such generated construction procedure data in the procedure storage section 170.

### (6) The Procedure Storage Section

The procedure storage section 170 stores the construction procedure data which shows the construction procedure of the real model determined by the procedure determination section 160. The construction procedure data is used for the generation of instructions by the instruction generation section 180 which will be described next.

### (7) The Instruction Generation Section

The instruction generation section 180 generates instructions IST which indicate to a user the construction procedure of the real model determined by the procedure determination section 160. In the present disclosure, the instructions are concepts which can include a manual, help, guidance, navigation or the like for supporting the work of the user. Note that the user who uses the instructions may be a same user as the user who constructed the real model, or may be a different user.

The instructions IST may be document data, for example, which shows in stages the work in which each element is attached to the real model in the order shown by the construction procedure data. The document data may be used for printing the document on paper, or may be used for inspecting the instructions on a screen. In addition to text, the document data can also include images such as illustrations or photographs. Further, the instruction generation section 180 may embed, into the document data, moving images which express a state in which at least one element is attached. The embedded moving images may be, for example, virtually generated animations, or may be images generated by using the input images acquired by the image acquisition section 120.

Further, the instruction generation section 180 may insert, into the instructions IST, a list of the elements included in the element configuration of the real model. By being provided with a list of elements, the user can appropriately prepare necessary elements prior to the start of construction of the real model. Further, the user can judge, by referring to the list of elements, whether an intended real model can be constructed by using an element set that the user possesses himself or herself.

Some examples of instructions generated by the instruction generation section 180 will be further described afterwards.

### [2-3. Example of the Flow of Processes]

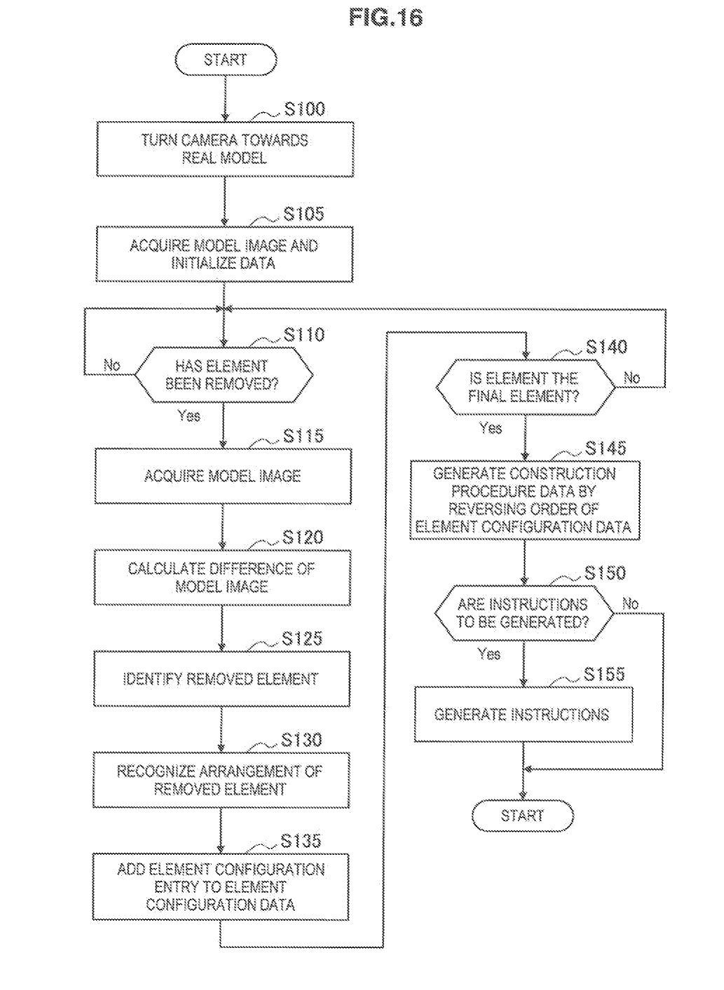

FIG. 16 is a flow chart which shows an example of the flow of processes executed by the information processing apparatus 100.

With reference to FIG. 16, in preparation for the processes, the camera 102 of the information processing apparatus 100 is turned towards the real model by a user (step S100). Then, the processes after this are started, in accordance with some user input detected via the user interface 104.

First, a model image of the completed real model is acquired as an input image by the image acquisition section 120, and the data is initialized (for example, a new model ID is allocated to the real model, and a completed image of the real model is stored) (step S105).

Next, the configuration recognition section 150 judges whether or not an element has been removed from the real model projected in the input image (step S110). The judgment here may be performed by monitoring the input image, or may be performed by receiving a user input which notifies that an element has been removed.

When it is judged that an element has been removed from the real model, the configuration recognition section 150 acquires a model image after the element removal (step S115). Further, the configuration recognition section 150 calculates a difference between the model image prior to the element removal and the model image after the removal (step S120). Then, the configuration recognition section 150 identifies the removed element in accordance with one of the above described first to third methods (step S125), and recognizes the arrangement (orientation and position) of the removed element (step S130).

Next, the procedure determination section 160 adds, to the element configuration data, an element configuration entry which includes element identification information and arrangement information input from the configuration recognition section 150 (step S135).

Next, the configuration recognition section 150 judges whether or not the removed element is the final element (step S140). The judgment here may be performed by recognizing the number of elements remaining in the real model, or may be performed by receiving a user input which notifies that the removal of elements is completed. In the case where the removed element is not the final element, the process returns to step S110, and the processes of step S110 to step S140 are repeated for the next removed element. In the case where the removed element is the final element, the process proceeds to step S145.

In step S145, the procedure determination section 160 determines the construction procedure by reversing the order of the entries within the element configuration data, and generates construction procedure data which shows the determined construction procedure (step S145).

Afterwards, in the case where the generation of instructions is to be continuously performed (step S150), the instruction generation section 180 generates instructions for the construction of the real model, based on the construction procedure data generated by the procedure determination section 160 (step S155).

### [2-4. Examples of Instructions]

### (1) The First Example

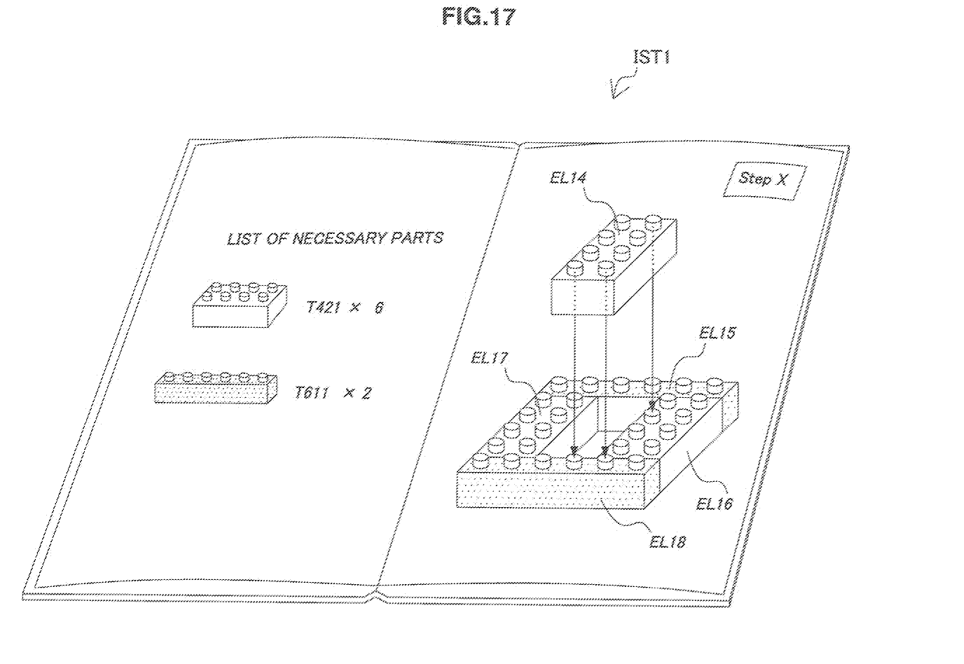

FIG. 17 is an explanatory diagram which shows a first example of instructions which can be created in accordance with the technology according to the present disclosure. With reference to FIG. 17, instructions IST1 are shown which are in a document printed on paper. A list of necessary parts (elements) for constructing the real model is disclosed on the left page of the instructions IST1. Further, a state in Which the element EL14 is to be attached to the real model in an X^{th} construction step is disclosed, in a form in which the orientation and position of this attachment are understood, on the right page of the instructions IST1. The disclosure of such a list and construction steps can be automatically generated by using the construction procedure data 174 such as that shown in the example of FIG. 15.

### (2) The Second Example

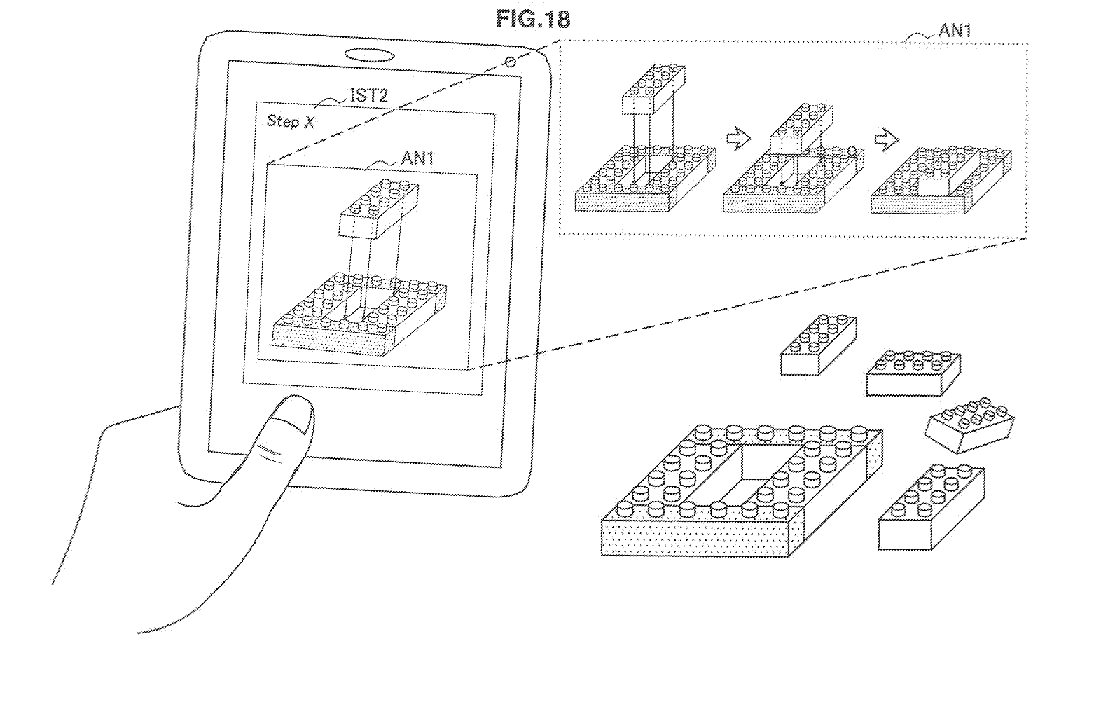

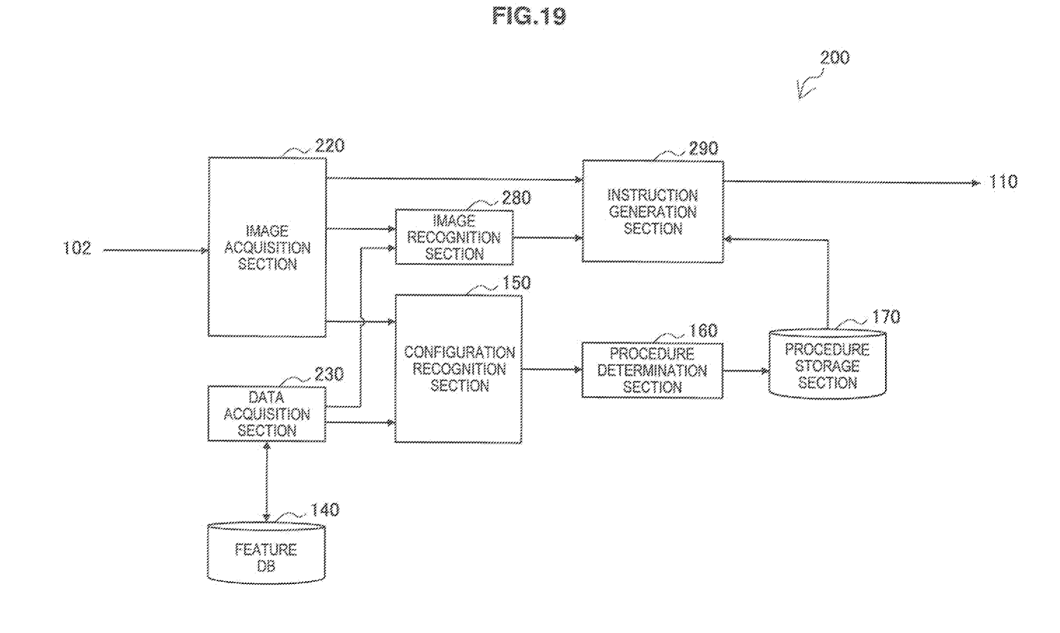

FIG. 18 is an explanatory diagram which shows a second example of instructions which can be created in accordance with the technology according to the present disclosure. With reference to FIG. 18, instructions IST2 are shown displayed on the screen of a user terminal. In the window of the instructions IST2, a state in which an element is to be attached to the real model in an X^{th} construction step is expressed by an animation AN1. When the attachment of an element indicated by the user is completed, an animation for the next construction step can be displayed on the window of the instructions IST2, automatically or in accordance with a user input such as touching the window or pressing a button.

### 3. Modified Example

FIG. 19 is a block diagram which shows an example of a configuration for the logical functions of an information processing apparatus 200 according to a modified example of the present disclosure, which provides instructions of a mode different to that of the two examples of instructions shown in FIGS. 17 and 18. With reference to FIG. 19, the information processing apparatus 200 includes an image acquisition section 220, a data acquisition section 230, a feature database 140, a configuration recognition section 150, a procedure determination section 160, a procedure storage section 170, an image recognition section 280, and an instruction generation section 290.

### (1) The Image Acquisition Section

The image acquisition section 220 acquires, in a construction procedure determination mode, a series of input images projecting the processes in which the individual elements are removed from the real model, similar to that of the above described image acquisition section 120. Also, the image acquisition section 220 outputs the acquired input images to the configuration recognition section 150. Further, the image acquisition section 220 acquires, in an instruction provision mode, a series of input images projecting the elements as the parts of the real model to be constructed by a user. Also, the image acquisition section 220 outputs the acquired input images to the image recognition section 280 and the instruction generation section 290. A user interface for switching between these modes may also be provided.

### (2) The Data Acquisition Section

The data acquisition section 230 outputs, in a construction procedure determination mode, feature data which shows the existing visual features of each of the elements to the configuration recognition section 150, similar to that of the above described data acquisition section 230. Further, the data acquisition section 230 outputs, in an instruction provision mode, this feature data to the image recognition section 280.

### (3) The Image Recognition Section

The image recognition section 280 recognizes the elements projected in an input image input from the image acquisition section 220, by using the feature data input from the data acquisition section 230. For example, the image recognition section 280 may recognize the type and position of the elements projected in the input image, by collating an existing feature quantity set including the feature data with a feature quantity set extracted from the input image. Also, the image recognition section 280 outputs an element recognition result to the instruction generation section 290.

### (4) The Instruction Generation Section

In the case where an incomplete real model or element is projected in a new input image, the instruction generation section 290 generates, in an instruction provision mode, instructions which relate to this real model or this element. The instructions generated here include display objects such as an annotation of a so-called AR (Augmented Reality). The content of the instructions can be determined based on an element recognition result input from the image recognition section 280. Also, the instruction generation section 290 displays the generated instructions on the screen superimposed on the input image.

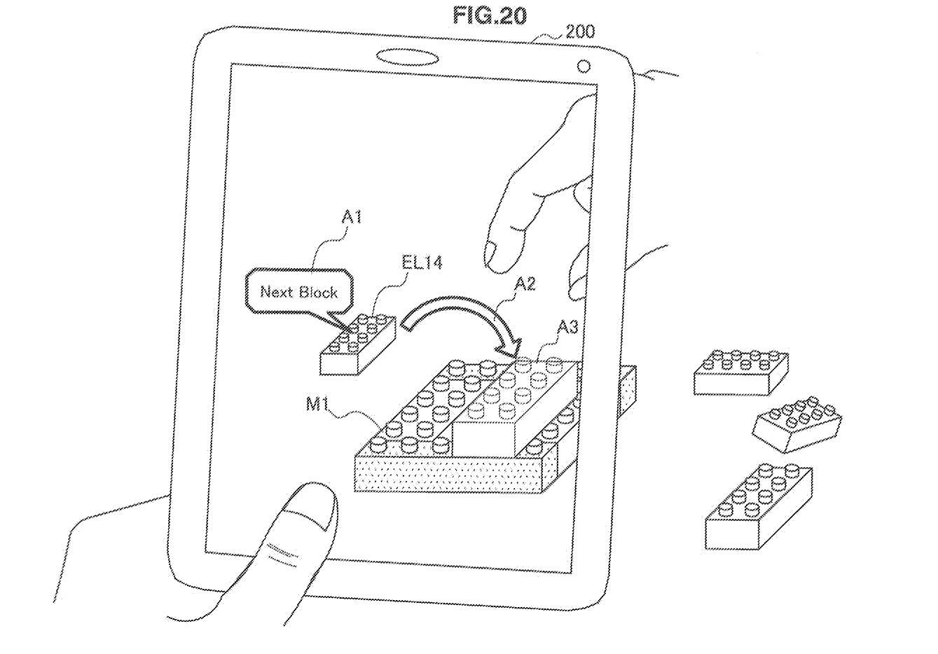

FIG. 20 is an explanatory diagram which shows an example of instructions which can be created in the present modified example. With reference to FIG. 20, an input image projecting an incomplete real model M1 and an element EL14 is displayed on the screen of the information processing apparatus 200. Three display objects A1, A2 and A3 are superimposed on this input image. The display object A1 is a message box which indicates that the next element to be attached to the real model M1 is the element EL14. The display object A2 is an arrow icon which indicates the position at which the element EL14 is to be attached. The display object A3 is an image which virtually shows a state in which the element EL14 is attached to the real model M1. A user can intuitively and easily construct a real model identical to that of a model originally constructed by another user, for example, while reviewing such instructions on the screen.

### 4. Conclusion

Up to here, embodiments of the technology according to the present disclosure have been described in detail, by using FIGS. 1 to 20. According to the above described embodiments, an element configuration of a real model can be recognized by using a series of input images projecting the processes in which the individual elements are removed by a user from the real model constructed from a plurality of elements, and a construction procedure for constructing this real model is determined based on the recognized element configuration. Therefore, even in a condition in which a complete digital expression of the model is not provided and only a real model exists which is actually and physically constructed, appropriate construction procedures for instructions related to this real model can be obtained. Further, since a user may not handle the model on a computer for obtaining the construction procedure, the above described mechanism can be easily used, even for a user who is not a specialist.

As a result of the above described mechanism being implemented, for example, it becomes possible for a new mode of communication in which original instructions for sharing a user's original model are exchanged between users. In this way, the appeal as an element set is enhanced, and an effect is also expected in which competiveness is improved in the commodity market.

Further, according to the above described embodiments, each time an element is removed from the real model, element identification information and arrangement information is recognized as an element configuration for each of the elements constituting this real model. Therefore, in the case where elements exist, in the completed real model, which are not able to be viewed from the outside, these elements can be reflected in the construction procedure by accurately recognizing the final arrangement of all the elements.

Further, according to the above described embodiments, an element configuration of the real model is recognized, based on the existing visual features of each element. For example, the elements are standardized, such as in blocks for a toy, and it is not difficult to make the visual features of these elements into a database in advance. Therefore, the above described technique based on the existing visual features of the elements is very suitable for such a usage. Further, as long as the elements are standardized, it is possible for the technology according to the present disclosure to be applied, by distributing feature data which shows these visual features after the fact, for an element set which has already been purchased.

Further, according to the above described embodiments, each element can be identified, based on the visual features appearing in a difference between a first model image prior to the removal of each element and a second model image after this removal. In this case, a user can obtain a construction procedure for instructions, by simply continuing to photograph the real model while the elements are removed and without imposing special operations for the identification of the elements. In the case where the elements are identified by using identification information which can be built into an element or attached to an element surface, the recognition accuracy of the element configuration can be improved even though there may be a necessary cost for introducing the identification information.

Note that the series of processes by each apparatus described in the present disclosure are typically implemented with software. For example, programs which constitute software implementing the series of processes are stored in advance in a storage medium (a non-transitory media) included within each apparatus or externally. Also, for example, each program is read in a RAM (Random Access Memory) at the time of execution, and is implemented by a processor such as a CPU.

Further, instead of being implemented on these apparatuses, a part of the logical functions of each apparatus may be implemented on an apparatus which exists within a cloud computing environment. In this case, information exchanged between the logical functions can be transmitted or received between the apparatuses via the communication interface 112 shown in the example of FIG. 3.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) An information processing apparatus, including:

an image acquisition section which acquires a series of input images projecting processes in which individual elements are removed from a real model constructed from a plurality of elements;

a recognition section which recognizes an element configuration of the real model by using the input images acquired by the image acquisition section; and

a determination section which determines a construction procedure for constructing the real model based on the element configuration recognized by the recognition section.
(2) The information processing apparatus according to (1),

wherein the element configuration recognized by the recognition section includes element identification information and arrangement information for each of the plurality of elements.
(3) The information processing apparatus according to (2), further including:

a data acquisition section which acquires feature data showing existing visual features of each of the plurality of elements,

wherein the recognition section recognizes the element configuration by collating features of elements projected in the input images with the feature data acquired by the data acquisition section.
(4) The information processing apparatus according to (3),

wherein the recognition section identifies each element by collating visual features appearing in a difference between a first model image prior to removal of each element and a second model image after this removal with the feature data.
(5) The information processing apparatus according to (3),

wherein the recognition section recognizes each element by collating visual features appearing in an element image of each element removed from the real model with the feature data.
(6) The information processing apparatus according to (4) or (5),

wherein the recognition section recognizes an arrangement of each element in the real model based on the difference between the first model image and the second model image.
(7) The information processing apparatus according to (2) or (3),

wherein each of the plurality of elements has identification information identifying the element within the element or on an element surface, and

wherein the recognition section identifies each element by reading the identification information.
(8) The information processing apparatus according to any one of (2) to (7),

wherein the determination section determines the construction procedure by reversing an order of the element identification information and the arrangement information described in the element configuration by an order of removed elements.
(9) The information processing apparatus according to any one of (2) to (8), further including:

a generation section which generates instructions which indicate to a user the construction procedure determined by the determination section.
(10) The information processing apparatus according to (9),

wherein in a case where an incomplete real model or element is projected in a new input image, the generation section superimposes the generated instructions on the new input image by generating the instructions which relate to the incomplete real model or element.
(11) The information processing apparatus according to (9),

wherein the instructions are document data which shows in stages work in which each element is attached to the real model by a reverse order of an order of removed elements.
(12) The information processing apparatus according to (11),

wherein the generation section embeds, in the document data, a moving image which expresses a state in which at least one element is attached.
(13) The information processing apparatus according to any one of (9) to (12),

wherein the generation section inserts, into the instructions, a list of elements included in the element configuration.
(14) An information processing method executed by an information processing apparatus, the method including:

acquiring a series of input images projecting processes in which individual elements are removed from a real model constructed from a plurality of elements;

recognizing an element configuration of the real model by using the acquired input images; and

determining a construction procedure for constructing the real model based on the recognized element configuration.
(15) A program for causing a computer which controls an information processing apparatus to function as:

an image acquisition section which acquires a series of input images projecting processes in which individual elements are removed from a real model constructed from a plurality of elements;

a recognition section which recognizes an element configuration of the real model by using the input images acquired by the image acquisition section; and

a determination section which determines a construction procedure for constructing the real model based on the element configuration recognized by the recognition section.

What is claimed is:

1. An information processing apparatus, comprising:
an image acquisition section which acquires a series of input images projecting processes in which individual elements are removed from a real model constructed from a plurality of elements;
a recognition section which recognizes an element configuration of the real model by using the input images acquired by the image acquisition section; and
a determination section which determines a construction procedure for constructing the real model based on the element configuration recognized by the recognition section.

2. The information processing apparatus according to claim 1,
wherein the element configuration recognized by the recognition section includes element identification information and arrangement information for each of the plurality of elements.

3. The information processing apparatus according to claim 2, further comprising:
a data acquisition section which acquires feature data showing existing visual features of each of the plurality of elements,
wherein the recognition section recognizes the element configuration by collating features of elements projected in the input images with the feature data acquired by the data acquisition section.

4. The information processing apparatus according to claim 3,
wherein the recognition section identifies each element by collating visual features appearing in a difference between a first model image prior to removal of each element and a second model image after this removal with the feature data.

5. The information processing apparatus according to claim 3,
wherein the recognition section recognizes each element by collating visual features appearing in an element image of each element removed from the real model with the feature data.

6. The information processing apparatus according to claim 4,
wherein the recognition section recognizes an arrangement of each element in the real model based on the difference between the first model image and the second model image.

7. The information processing apparatus according to claim 2,
wherein each of the plurality of elements has identification information identifying the element within the element or on an element surface, and
wherein the recognition section identifies each element by reading the identification information.

8. The information processing apparatus according to claim 2,
wherein the determination section determines the construction procedure by reversing an order of the element identification information and the arrangement information described in the element configuration by an order of removed elements.

9. The information processing apparatus according to claim 2, further comprising:
a generation section which generates instructions which indicate to a user the construction procedure determined by the determination section.

10. The information processing apparatus according to claim 9,
wherein in a case where an incomplete real model or element is projected in a new input image, the generation section superimposes the generated instructions on the new input image by generating the instructions which relate to the incomplete real model or element.

11. The information processing apparatus according to claim 9,
wherein the instructions are document data which shows in stages work in which each element is attached to the real model by a reverse order of an order of removed elements.

12. The information processing apparatus according to claim 11,
wherein the generation section embeds, in the document data, a moving image which expresses a state in which at least one element is attached.

13. The information processing apparatus according to claim 9,
wherein the generation section inserts, into the instructions, a list of elements included in the element configuration.

14. An information processing method executed by an information processing apparatus, the method comprising:
acquiring a series of input images projecting processes in which individual elements are removed from a real model constructed from a plurality of elements;
recognizing an element configuration of the real model by using the acquired input images; and
determining a construction procedure for constructing the real model based on the recognized element configuration.

15. A program for causing a computer which controls an information processing apparatus to function as:
an image acquisition section which acquires a series of input images projecting processes in which individual elements are removed from a real model constructed from a plurality of elements;
a recognition section which recognizes an element configuration of the real model by using the input images acquired by the image acquisition section; and
a determination section which determines a construction procedure for constructing the real model based on the element configuration recognized by the recognition section.
